(19) United States
(12) Patent Application Publication
(10) Pub. No.: US 2012/0005913 A1
(43) Pub. Date: Jan. 12, 2012

(54) CLOTHES DRYER LINT FILTER MECHANISM

(76) Inventor: Donald E. McKinley, Gainesville, TX (US)

(21) Appl. No.: 13/111,793

(22) Filed: May 19, 2011

Related U.S. Application Data
(63) Continuation-in-part of application No. 12/220,670, filed on Jul. 28, 2008, now abandoned.

(51) Int. Cl. F26B 21/06

(52) U.S. Cl. 34/82

(57) ABSTRACT

A clothes dryer lint filter mechanism for filtering the clothes dryer exhaust air and for directing the heat and humidity inherent in the clothes dryer exhaust air either into the interior of a building or the exterior of a building, the clothes dryer lint filter mechanism may include a back member, a front member being pivotally connected to the back member, an inlet port to be connected to a clothes dryer. The front member may include a first outlet port, and the back member may include a second outlet port. The first outlet port and the second outlet port may be selectively controllable. The first outlet port and the second outlet port may be selectively controlled by a control arm, and the housing device may include a filter which is pivotally connected to the front member. The filter may pivot to a substantially horizontal position when the front member is in a open position, and the filter may pivot to a position between the input port and the first outlet port and the second outlet port when the front member is in a closed position.

### PRIORITY

The present invention is a continuation in part (CIP) of a previous application with a serial number of Ser. No. 12/220,670 which was filed on Jul. 28, 2008.

### BACKGROUND OF THE INVENTION

1. Field of the Invention

The present invention relates generally to the fields of clothes dryer filters and vents, and more specifically, is directed to a device of both further filtering the clothes dryer exhaust and directing the warm, humid exhaust either to the exterior of a building or into the interior of a building.

2. Description of Prior Art

Clothes drying machines typically use an electrical heating element or gas burners to provide heat that is directed into a rotating drum that distributes the heated air across the wet clothing. After the heated air is forced into the drum and across the clothes, it is directed into the dryer exhaust vent for removal to the exterior of the clothes drying machine, along with lint and dust particles. Many devices already in existence handle the dryer exhaust. Some require water to trap the lint and dust particles. Others contain many parts that may be subject to maintenance issues. Still others filter the dryer exhaust and direct it only to the interior of a building, which may be undesirable during summer months. Yet, others contain multiple filtering elements, which may cause increased maintenance time and cost issues.

U.S. Pat. No. 4,183,150, filed Oct. 21, 1976 by Robert B. Nash discloses an electric clothes dryer filter that directs the dryer exhaust to a filter element consisting of a bag which is inflated by the flowing exhaust gas and directs the filtered gas only to the interior of the building.

U.S. Pat. No. 3,999,304, filed Jul. 18, 1975 by Edward B. Doty discloses a clothes dryer filter and exhaust system which contains multiple filter elements, has moving parts which if improperly adjusted, may restrict the exhaust flow to the point where the heating element may be damaged, and which exhausts the airflow into the interior of a building only.

U.S. Pat. No. 4,395, 831, filed Mar. 18, 1977 by Edward G. Nielson discloses a dryer vent which may direct the unfiltered exhaust to the exterior of a building, or alternatively to the interior of a building. When directed to the interior of a building, the filtered exhaust blows from the direction of the rear of the dryer towards the front of the dryer at a height which would blow the air into the face of a person standing in front of the dryer.

U.S. Pat. No. 4,338,731, filed Sep. 22, 1980 by Sidney J. Shames and Harold Shames discloses a vent for a clothes dryer has moving parts which may become unreliable due to accumulation of lint and dust.

U.S. Pat. No. 5,210,960, filed Sep. 20, 1989 by Robert Walsh discloses a filter and humidifier that user a water container, which may cause issues with water spillage, cleaning problems and disposal of wet heat.

### SUMMARY OF THE INVENTION

A housing device for directing warm air may include a back member, a front member being pivotably connected to the back member, an inlet port to be connected to a clothes dryer. The front member may include a first outlet port, and the back member may include a second outlet port. The first outlet port and the second outlet port may be selectively controllable.

The first outlet port and the second outlet port may be selectively controlled by a control arm, and the housing device may include a filter which is pivotally connected to the front member.

The filter may pivot to a substantially horizontal position when the front member is in a open position, and the filter may pivot to a position between the input port and the first outlet port or the second outlet port when the front member is in a closed position.

The first outlet port may exhaust to the interior, and the second outlet port may exhaust to the exterior.

The filter may be mounted on a grid support device, and the grid support device may include upward extending fingers to restrain the filter.

### BRIEF DESCRIPTION OF THE DRAWINGS

FIG. 1 is a perspective drawing of the entire assembly, showing the rectangular housing, the filter element assembly cylindrical body, the dryer exhaust inlet and the two outlets.

FIG. 2 is a side view of the cylindrical body showing the dryer exhaust inlet, the framework of the cylindrical body and a portion of the filter element.

FIG. 3 is a side view of the cylindrical body without the filter element.

FIG. 4 is a perspective view of the cylindrical body and part of the filter element.

FIG. 5 is a view of the cylindrical body and the filter element shown sitting on the floor without the rectangular housing.

FIG. 6 is a view of the cylindrical housing and filter attached to a wall without the rectangular housing.

FIG. 7 is an end view of the cylindrical housing showing one set of slots which are used to attach wall brackets or feet for mounting without the rectangular housing.

FIG. 8 is an opposite end view of the cylindrical housing showing one slot which is used to attach wall brackets for mounting without the rectangular housing.

FIG. 9 is a view of one of the feet which are used to set the cylindrical body on the floor without the rectangular housing.

FIG. 10 is a view of the wall mounting bracket used to mount the cylindrical body to the wall without the rectangular housing.

FIG. 11 is a view of the cylindrical body frame without the filter element or the flexible plastic grid material.

FIG. 12 is a view of the plastic grid material shown before being formed around the cylindrical frame.

FIG. 13 is an end view of the rectangular body of the filter assembly showing the circular opening that the cylindrical body fits into.

FIG. 14 is a view of the rectangular housing attached to the wall;

FIG. 15 is a perspective view of the entire assembly of the present invention;

FIG. 16 illustrates a bottom view of the hollow heat distributing device;

FIG. 17 illustrates a side view of the hollow heat distributing device;

FIG. 18 illustrates another side view of the hollow heat distributing device;

FIG. 19 illustrates a side view of the hollow heat distributing device in an open position;

FIG. 20 illustrates a side view of the front member of the hollow heat distributing device;

FIG. 21 illustrates a side view of the airflow within the hollow heat distributing device;

FIG. 22 illustrates a side view of the hollow heat distributing device in an open position, showing the grid and filter;

FIG. 23 illustrates a top view of the grid device;

FIG. 24 illustrates a side view of the grid device;

FIG. 25 illustrates a top view of the filter;

FIG. 26 illustrates a front view of another embodiment of the front member;

FIG. 27 illustrates a top view of another embodiment of the front member;

FIG. 28 illustrates an interior view of the hollow heat distributing device from a first side;

FIG. 29 illustrates an interior view of the hollow heating distributing device from a second side.

### DETAILED DESCRIPTION OF THE PREFERRED EMBODIMENT

It is an objective of the present invention to provide a clothes dryer lint filter which may be mounted on a wall adjacent to the dryer, or on the floor near the clothes dryer.

It is a further objective of the present invention that the filtered exhaust gas may be directed to the exterior of a building, or to the interior of a building. In one embodiment, this is accomplished by having one of two “knockouts” left in place and the other removed which will allow the exhaust to follow only one path. If it is desired to redirect the exhaust, the open knockout may be plugged by either a sliding gate device, or a simple press in plug, and the remaining knockout may be removed.

It is again a further objective of the present invention to provide a filter element with a comparatively large surface area for the space used.

It is yet a further objective of the present invention that the filter element will be disposable, and may be easily removed for disposal and replacement.

It is a still further objective of the present invention that is shall be easy to determine the amount of lint and dust which has accumulated on the

disposable filter element by observing the filter element surface directly by looking into the transparent end of the device.

It is also a further objective of the present invention that the dryer exhaust tube may be affixed directly to the end of the cylinder that holds the disposable filter element.

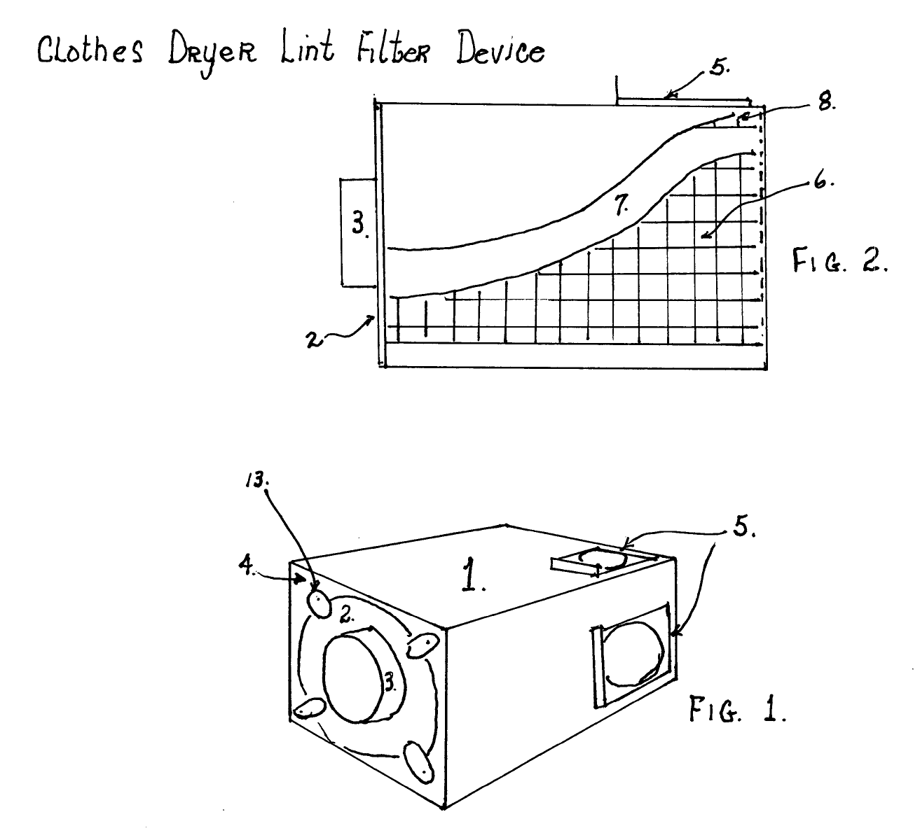

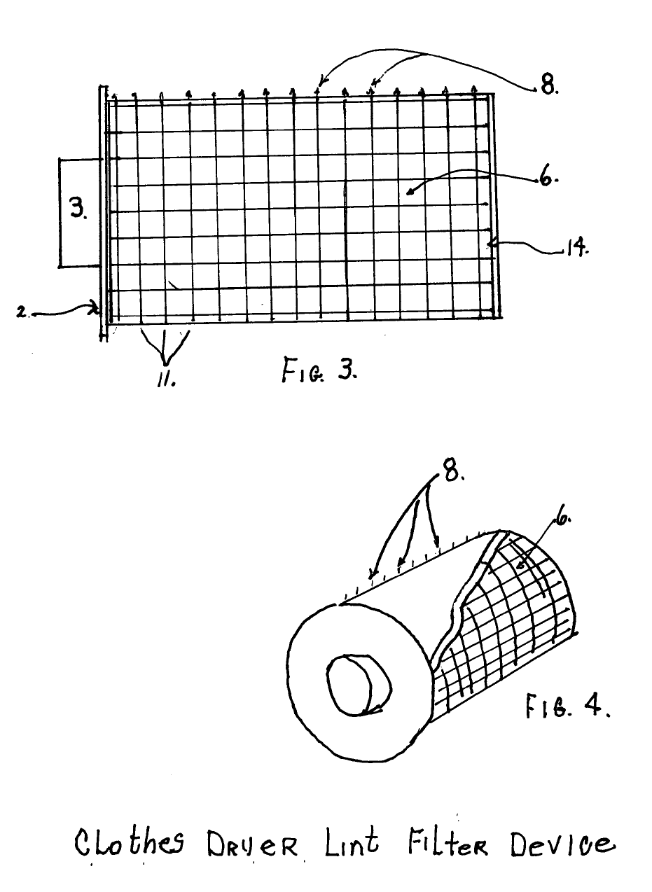

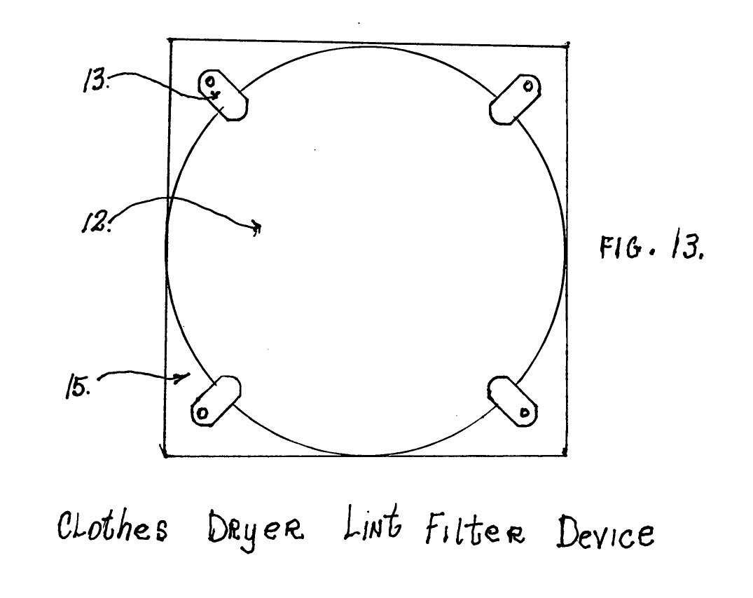

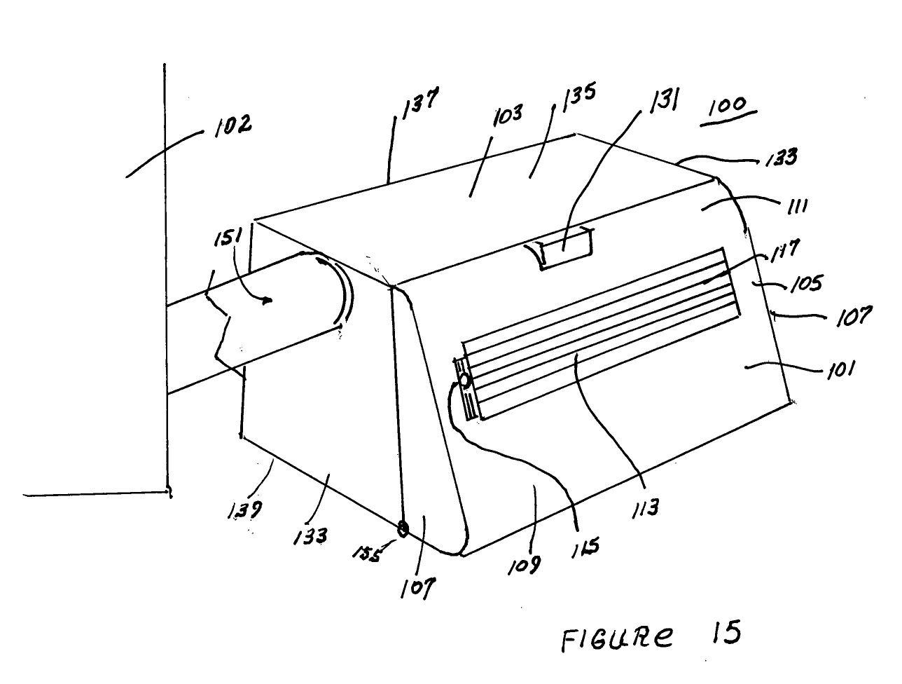

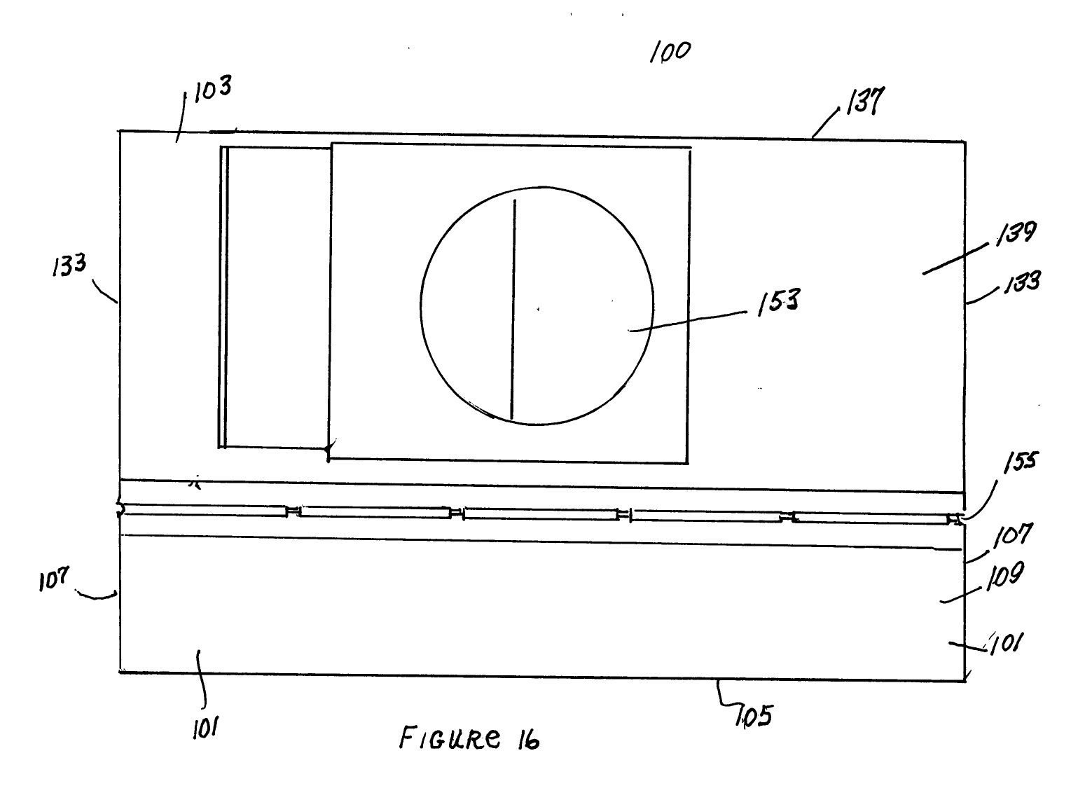

Yet still another objective of the present invention is that the filter element cylindrical body and filter element may be mounted either on a wall or set on the floor, without using the rectangular housing. This configuration may be desirable so long as it is the intention of the user to direct the filtered clothes dryer exhaust into the interior of a building only.
1. A clothes dryer lint filter device 1 formed in accordance with the present invention is shown in FIG. 1. Its components include, but are not necessarily limited to a rectangular housing 1, and a cylindrical body 14 which includes a disposable filter element. The rectangular housing is currently fabricated from sheets of acrylic material and glued together, but future production methods of mass production may include plastic injection molding techniques, or other such means as to produce high quality, strength and durability.
2. A cylindrical body 14 is shown in FIG. 2 which holds a filter element 7 that is wrapped around the cylindrical body 14. The cylindrical body 14 and filter element 7 are shown in FIG. 1 inserted into the rectangular body 1 and secured with rotating latches 4. The inlet port 3 shown in FIG. 1 provides a means of connecting a flexible duct from a clothes dryer to the clothes dryer lint filter device. Two outlet ports 5 are shown in FIG. 1. One outlet port may be connected to a flexible duct for directing the filtered dryer exhaust to the exterior of a building. The other outlet port may be used to direct the filtered dryer exhaust to the interior of a building.
3. The cylindrical body 14 shown in FIG. 3 is comprised of a grid material obtainable from a variety of sources. The grid material 6 of FIG. 12 is comprised of squares which may be in one embodiment approximately 1 inch by 1 inch in size, and is flexible so that it may be formed into a cylinder. The flexible grid 6 is wrapped around the cylindrical body 14 of FIG. 11 and secured in place with plastic tie straps 11 shown in FIG. 3. Those familiar with the art can appreciate that a variety of other means may be used to secure the plastic grid material to the cylindrical body, such as adhesives, wire, screws or the like. In mass production, the rectangular body and the wire grid may be fabricated entirely using plastic injection molding techniques, thus eliminating the need to fabricate and attach the plastic grid material to the cylindrical body entirely.
4. The cylindrical body 14 of FIG. 3 depicts small wire pins 8 that are imbedded into holes in the framework of the cylindrical body. These pins are used to secure both ends of the disposable filter material 7 to the cylindrical body 14. One end of the filter material 7 is attached over the pins 8 and wrapped around the cylindrical body 14 of FIG. 2, with the other end also attached over the pins 8 to complete the attachment of the filter material onto the cylindrical body as shown in FIG. 2 and FIG. 4. Those familiar with such devices can envision other means of attaching the filter material 7 to the cylindrical body 14, such as self adhesive strips, rubber bands, or other similar means.
5. The end plate 2 of FIG. 2 is of a diameter that is slightly larger that the opening 12 of FIG. 13. The cylindrical body 14 of FIG. 4 is inserted into the rectangular housing 1 of FIG. 1. The end plate 2 of FIG. 2 rests against the end 15 of the rectangular housing of FIG. 13. The cylindrical body assembly 14 of FIG. 4 is secured to the rectangular housing by means of rotating attachment devices 4 that rotate on screws 13 as depicted in FIG. 1. Once the rotating attachment devices 4 are closed, the cylindrical body comprised of the framework 10, grid material 6 and filter element 7 of FIG. 2 is attached securely in place in the rectangular housing. Other means may be used to connect the attachment devices 4 to the rectangular housing, such as pins or bolts.
6. The cylindrical body assembly of FIG. 2 contains in the outer end a metallic duct material 3 of a circumference suitable for attachment of a flexible clothes dryer exhaust hose. The flexible clothes dryer exhaust hose may be secured with metal snap rings, tie straps or other similar means that normally are supplied with said flexible clothes dryer exhaust hose.
7. The outlet ports 5 shown in FIG. 1 are situated in the rectangular housing 1 of FIG. 1. The design intent is that one outlet port may be closed while the other is open. One of the outlet ports 5 may be open and connected to a second flexible clothes dryer exhaust hose that is directed to the outside of a building. This arrangement may be used in summer months when it is not desirable to add heat and humidity into the interior of a building. In this case, the second outlet port 5 would be closed. In winter months, the outlet port 5 connected to the exterior of the building by means of the flexible clothes dryer exhaust hose would be closed and the other outlet port 5 would be open to allow filter, warm, moist air into the interior of a building. Those familiar with such contrivances may envision other means of opening and closing the ports 5, such as with rubber plugs or knockouts, or magnetic covers.
8. The filter material 7 of FIG. 2 will eventually become covered with lint and dust during the normal operation of the clothes drying machine. Since the clothes dryer filter mechanism of this invention is subsequent to the primary clothes drying machine filter element built into the clothes dryer itself, the flexible filter material 7 will not become covered as quickly as the primary filter. When it is evident that a covering of lint and dust has accumulated, as observed through the end or sides of the filter mechanism, the attachment devices 4 are rotated to allow the cylindrical body 14 to be removed from the rectangular housing 1. The used filter element 7 is removed, disposed of and a new filter 7 element is installed, as described in paragraph 4 above.

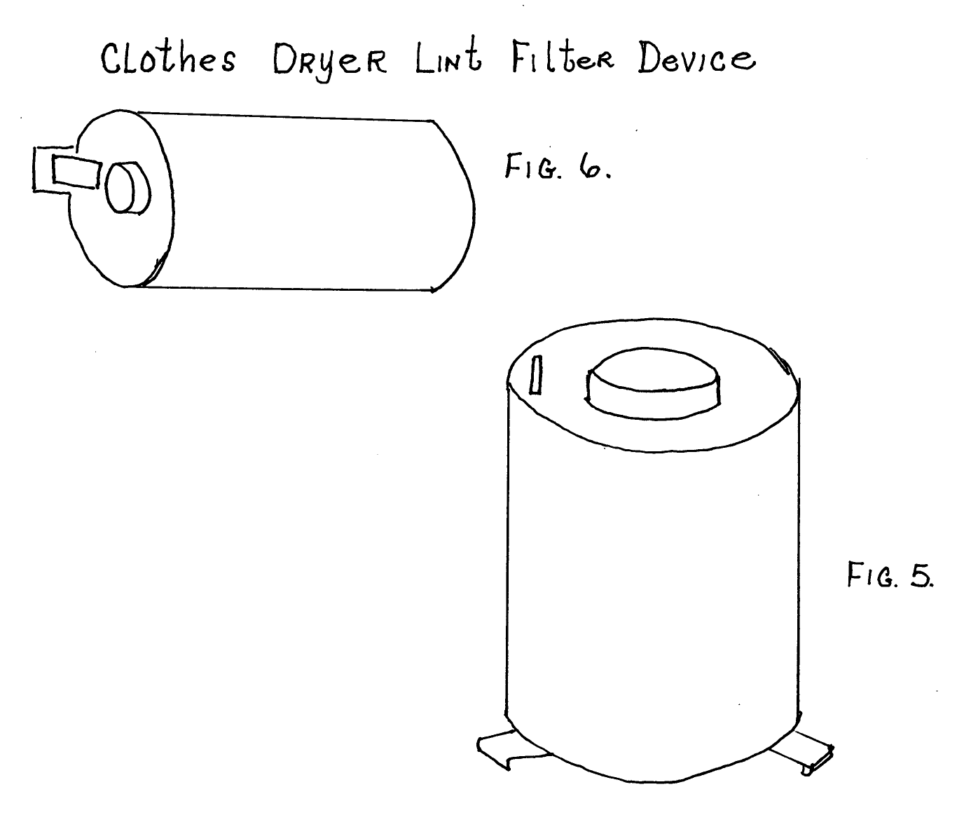

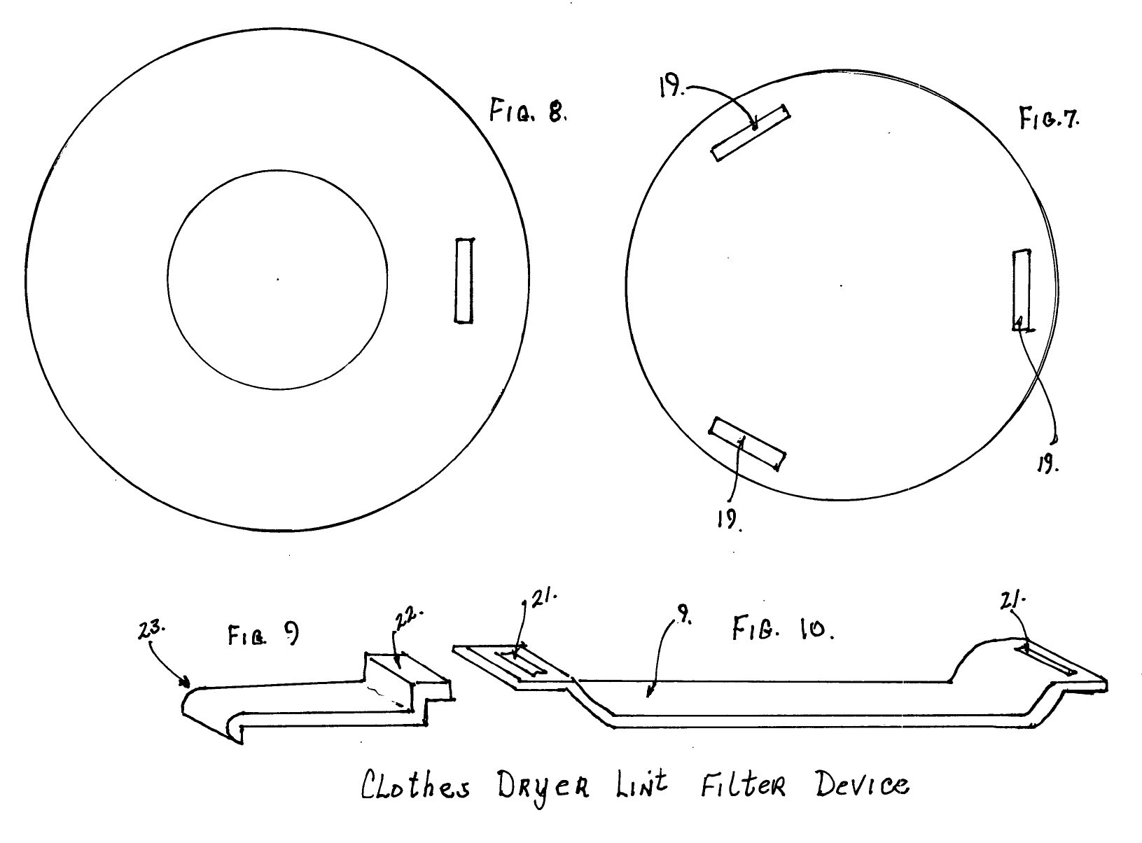

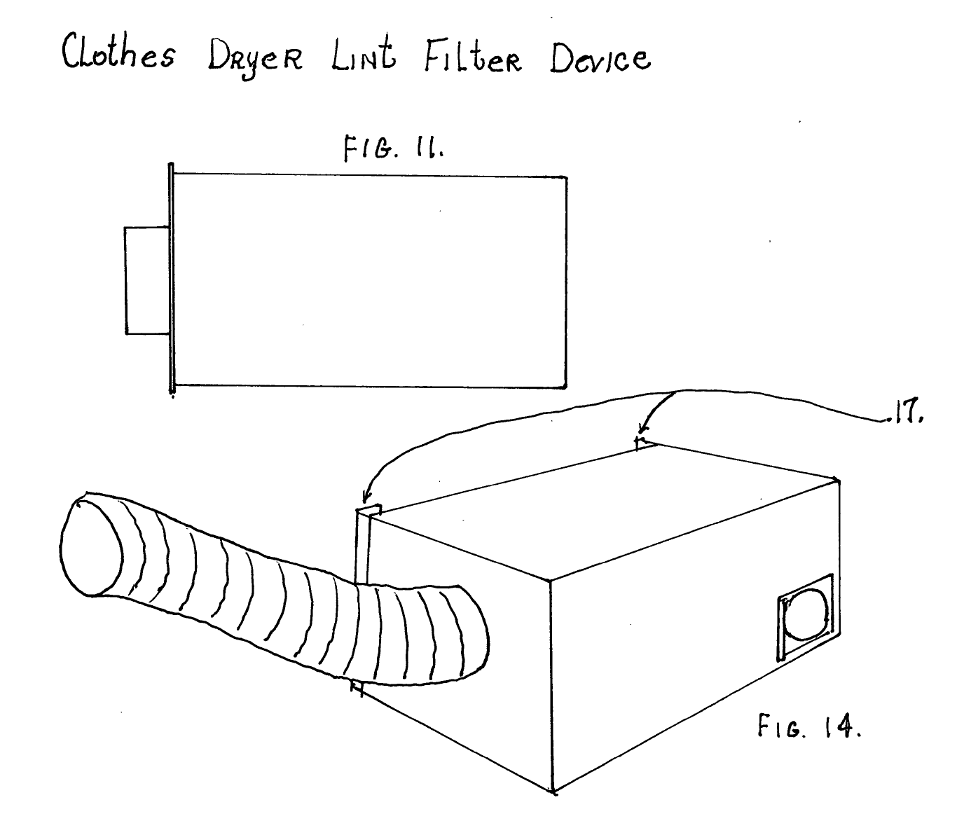

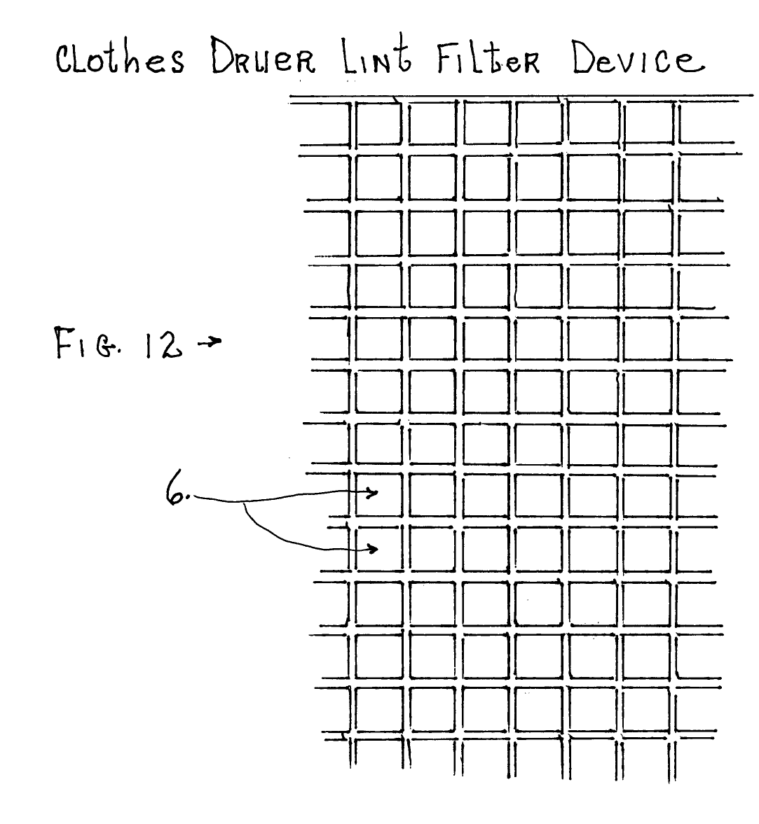

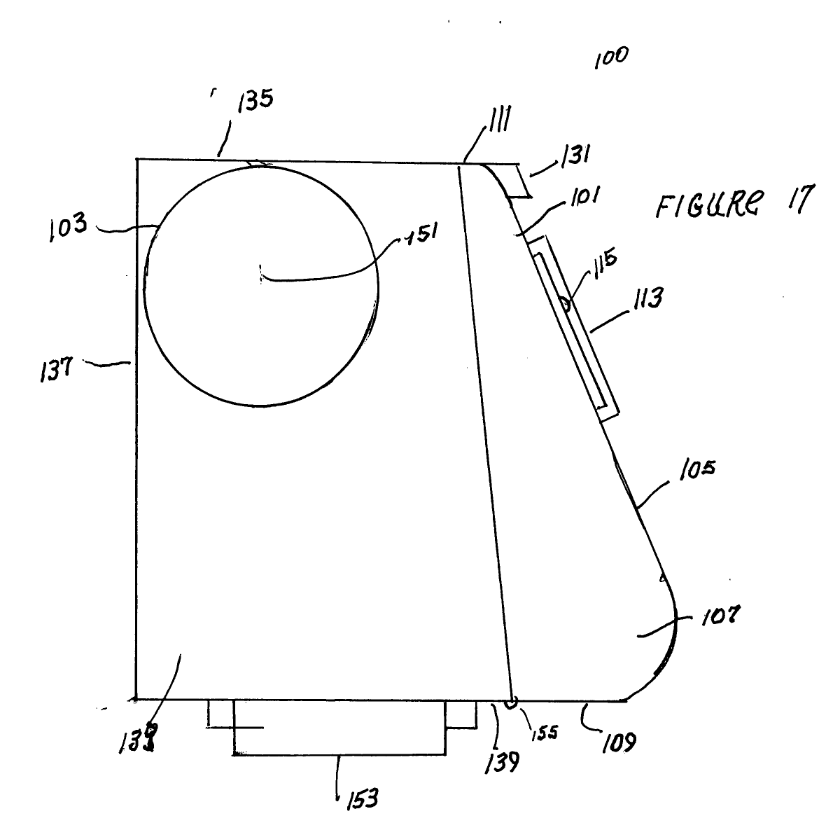

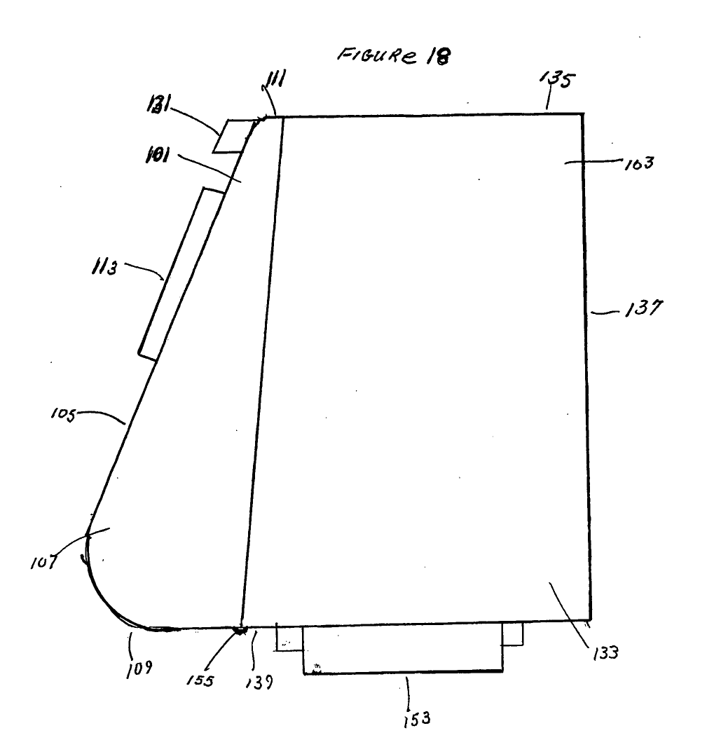

9. The clothes dryer filter assembly of FIG. 1 is shown in FIG. 14 attached to a vertical wall by means of mounting brackets 17 which are attached to the wall by screws, hollow wall anchors, or a multiplicity of other common means. The clothes dryer filter assembly of FIG. 1 is shown in FIG. 15 sitting on its end on the floor. Those whom are familiar with such arrangements can envision other means of mounting, such as on a table or on a shelf.
10. FIG. 5 and FIG. 6. show yet another application of the filter assembly in which the cylindrical body 14 is resting on the floor without using the rectangular housing. Again, in FIG. 6, the cylindrical body 14 is depicted connected to a wall without using the rectangular housing assembly. These applications may be preferable when the filtered, warm, humid air is always intended to be directed into the interior of a building. In such cases, as show in FIG. 7 and FIG. 8, slots are fashioned into the ends of the cylindrical body 7. These slots provide a place for the clips of FIG. 9 to attach to the cylindrical body 7 by means of one end 22 of the clip, which is inserted into one of the three slots 19 of FIG. 7. This provides a means whereby the cylindrical body 14 shown in FIG. 5 may be placed directly on the floor or another such flat surface. FIG. 6 shows yet another means of attachment such that two of the clips of FIG. 9 are used. One clip is inserted into a slot 20 and 19 into the opposite ends of the cylindrical body. In this embodiment, the mounting bracket of FIG. 10 is connected to a wall using screws, hollow wall anchors or other such similar means. An end 23 of the clip shown in FIG. 9 is inserted into the slot 21 in the end of the bracket shown in FIG. 10. This embodiment allows the cylindrical body to be mounted directly to a wall without the rectangular housing 1. One benefit of this embodiment is that the filter element 7 can be changed without removing the cylindrical body 14 from the rectangular housing 1 and then replacing it.

FIG. 15 illustrates a perspective view of the hollow heat distributing device 100 which may include a front member 101 and a back member 103, and the front member 101 may include a front wall 105, a pair of opposing side walls 107 connected to the front wall 105, a bottom wall 109 connected to the front wall 105 and the side walls 107 and a top wall 111 which may be connected to the front wall 105 and the side walls 107. The front wall 105 may include a slanted portion and may include a first outlet port 113 which may be controlled by a control arm 115 which may slide between a open position of the outlet port 113 and a closed position of the outlet port 113 and control the amount of filtered air which may exhaust from the outlet port 113. The outlet port 113 may include louvers which may include pivoting air guides 117 which may pivot in order to open and close the outlet port 113. The top wall 111 may include a latch device 131 to allow the front member 101 to pivot to allow access to the interior of the hollow heat distributing device 100.

The back member 103 may include a pair of opposing back side walls 133 which may cooperate with the side walls 107 of the front member 101 a back top wall 135 to cooperate with the top wall 111, a back wall 137 to connect to the back top wall 135, to the back side walls 133 and to the back bottom wall 139 which may cooperate with the bottom wall 109. The back side wall 133 may include an exhaust inlet 151 which may be connected to the exhaust of the clothes dryer 102.

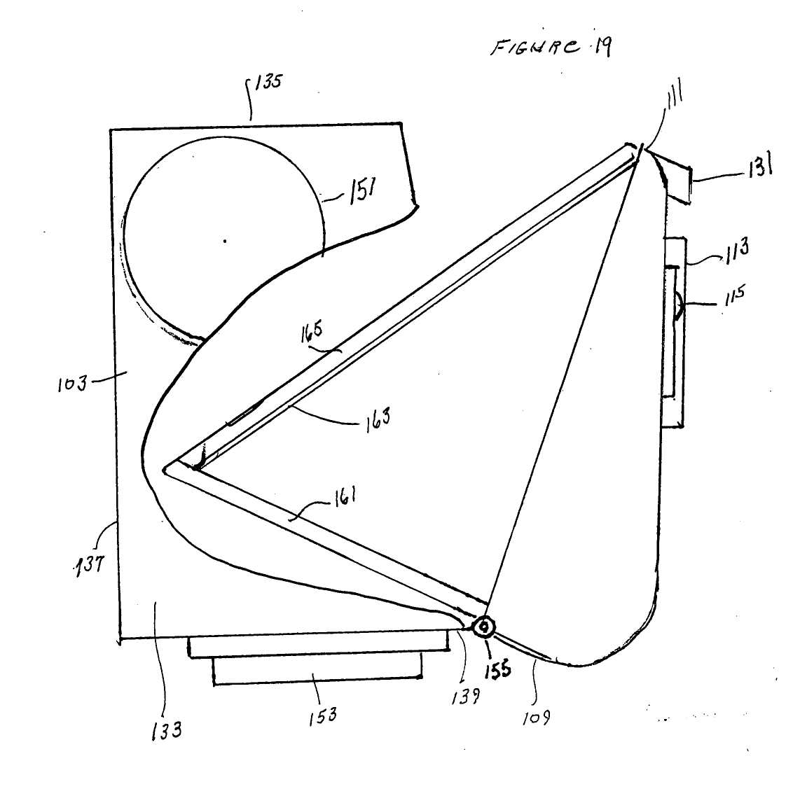

FIG. 16 illustrates a bottom view of the hollow heat distributing device 100 which may include a front member 101 and a back member 103, and the front member 101 may include a front wall 105, a pair of opposing side walls 107 connected to the front wall 105, a bottom wall 109 connected to the front wall 105 and the side walls 107.

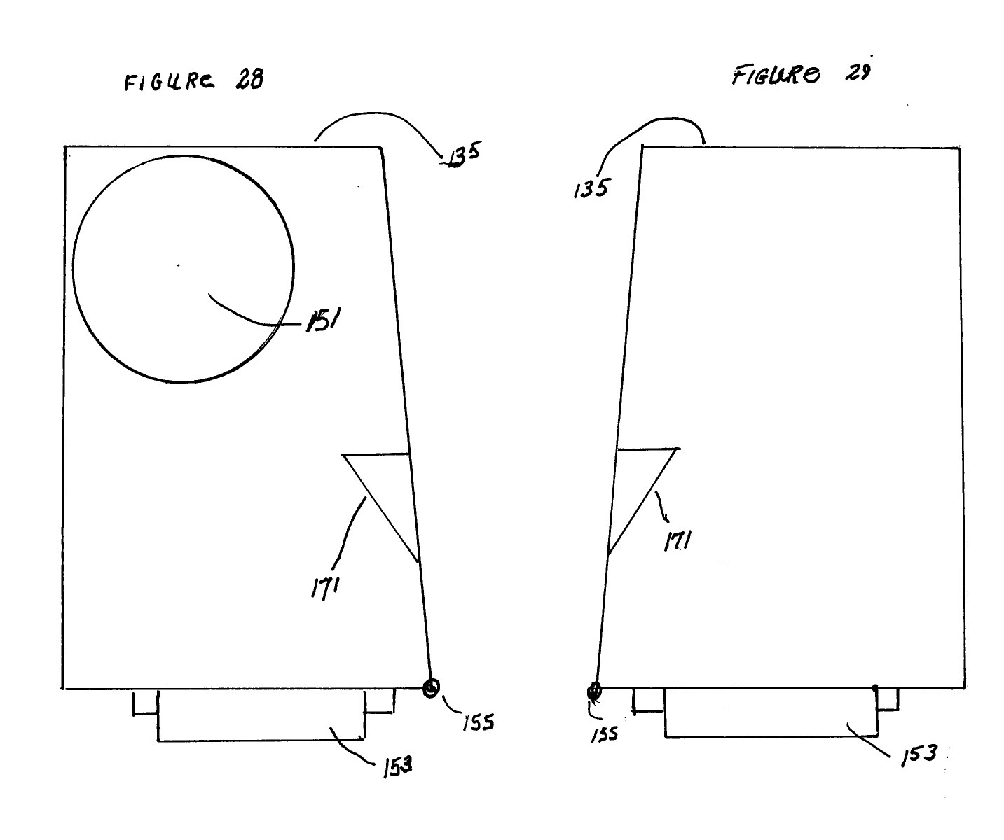

The back member 103 may include a pair of opposing back side walls 133 which may cooperate with the side walls 107 of the front member 101, a back wall 137 to connect to the back top wall 135, to the back side walls 133 and to the back bottom wall 139 which may cooperate with the bottom wall 109. The back bottom wall 139 may include a second exhaust outlet 153 to exhaust the filtered dryer air. The control arm 115 as shown in FIG. 28 controls the first outlet port 113 and the second outlet port 153 such that when the first outlet port 113 is fully open, the second outlet port 153 is closed, when the first outlet port 113 is closed, the second outlet port 153 is fully open and when the first outlet port 113 is partially open, the second outlet port 153 is partially open.

FIG. 16 additionally illustrates a pivoting device 155 connected to the bottom wall 109 and the back bottom wall 139 and illustrates that the pivoting device 115 may be a hinge to pivot the bottom wall 109 with respect to the back bottom wall 139.

FIG. 17 illustrates a side view of the hollow heat distributing device 100 which may include a front member 101 and a back member 103, and the front member 101 may include a front wall 105, a pair of opposing side walls 107 connected to the front wall 105, a bottom wall 109 connected to the front wall 105 and the side walls 107 and a top wall 111 which may be connected to the front wall 105 and the side walls 107. The front wall 105 may include a slanted portion and may include a first outlet port 113 which may be controlled by a control arm 115 as shown in FIG. 28 which may slide between a open position of the outlet port 113 and a closed position of the outlet port 113 and control the amount of filtered air which may exhaust from the outlet port 113. The outlet port 113 may include louvers which may include pivoting air guides 117 which may pivot in order to open and close the outlet port 113. The top wall 111 may include a latch device 131 to allow the front member 101 to pivot to allow access to the interior of the hollow heat distributing device 100.

The back member 103 may include a pair of opposing back side walls 133 which may cooperate with the side walls 107 of the front member 101 a back top wall 135 to cooperate with the top wall 111, a back wall 137 to connect to the back top wall 135, to the back side walls 133 and to the back bottom wall 139 which may cooperate with the bottom wall 109. The back side wall 133 may include an exhaust inlet 151 which may be connected to the exhaust of the clothes dryer. The first outlet port 113 may exhaust into the interior of the home while the second outlet port 115 may exhaust into the exterior.

FIG. 18 illustrates a side view of the hollow heat distributing device 100 which may include a front member 101 and a back member 103, and the front member 101 may include a front wall 105, a pair of opposing side walls 107 connected to the front wall 105, a bottom wall 109 connected to the front wall 105 and the side walls 107 and a top wall 111 which may be connected to the front wall 105 and the side walls 107. The front wall 105 may include a slanted portion and may include a first outlet port 113 which may be controlled by a control arm 115 (not shown in FIG. 18) which may slide between a open position of the outlet port 113 and a closed position of the outlet port 113 and control the amount of filtered air which may exhaust from the outlet port 113. The outlet port 113 may include louvers which may include pivoting air guides 117 which may pivot in order to open and close the outlet port 113. The top wall 111 may include a latch device 131 to allow the front member 101 to pivot to allow access to the interior of the hollow heat distributing device 100.

FIG. 19 illustrates a side view of the hollow heat distributing device 100 which may include a front member 101 and a back member 103, and the front member 101 may include a front wall 105, a pair of opposing side walls 107 connected to the front wall 105, a bottom wall 109 connected to the front wall 105 and the side walls 107 and a top wall 111 which may be connected to the front wall 105 and the side walls 107. The front wall 105 may include a slanted portion and may include a first outlet port 113 which may be controlled by a control arm 115 (not shown in FIG. 19) which may slide between a open position of the outlet port 113 and a closed position of the outlet port 113 and control the amount of filtered air which may exhaust from the outlet port 113. The outlet port 113 may include louvers which may include pivoting air guides 117 which may pivot in order to open and close the outlet port 113. The top wall 111 may include a latch device 131 to allow the front member 101 to pivot to allow access to the interior of the hollow heat distributing device 100.

FIG. 19 illustrates that the front member 101 has been pivoted with respect to the back member 103 in order to provide access to the interior of the hollow heat distributing device 100.

The back member 103 may include a pair of opposing back side walls 133 which may cooperate with the side walls 107 of the front member 101 a back top wall 135 to cooperate with the top wall 111, a back wall 137 to connect to the back top wall 135, to the back side walls 133 and to the back bottom wall 139 which may cooperate with the bottom wall 109. The back side wall 133 may include an exhaust inlet 151 which may be connected to the exhaust of the clothes dryer.

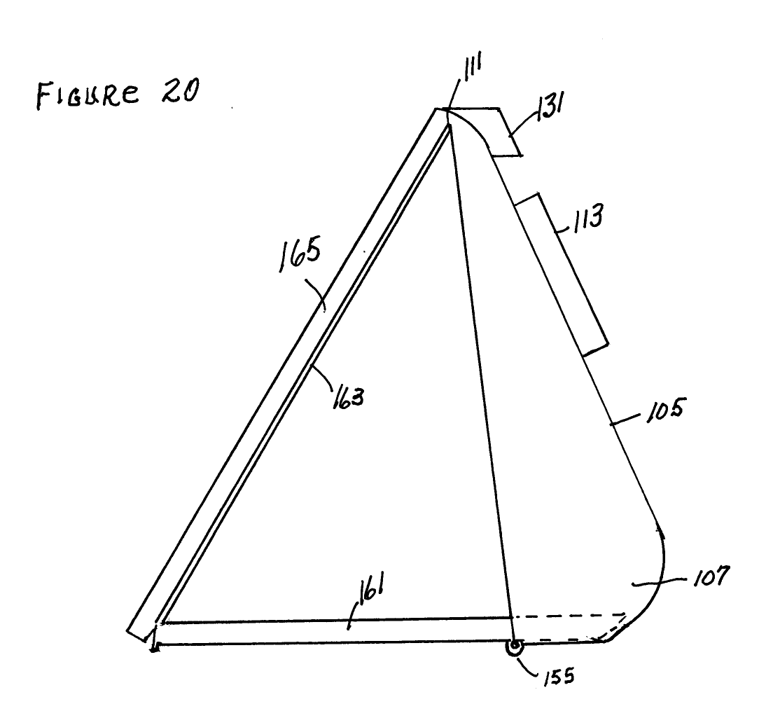

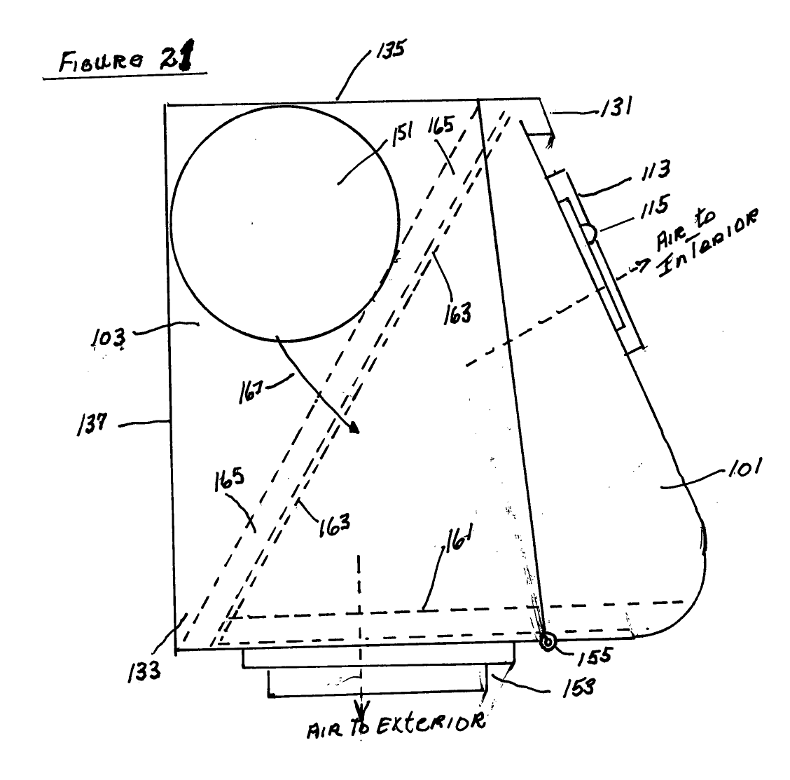

FIG. 20 illustrates the front member 101 which may include the latch device 131 the first outlet port 113, the front wall 105, the top wall 111 and the side wall 107. FIG. 20 additionally illustrates a grid support device 163 which may be pivotably connected to the top wall 111 for example by a hinge, and a grid support device 163 to support a filter 165 which may filter the air from the exhaust inlet 151. The grid support device 163 may be held in position by a pivot arm 161 which may be pivotably connected to the front member 101 and may include a grid of intersecting support members.

FIG. 21 illustrates the front member 101 in a closed position which may include the latch device 131 the first outlet port 113, the front wall 105, the top wall 111 and the side wall 107. FIG. 21 additionally illustrates a grid support device 163 which may be pivotally connected to the top wall 111 for example by a hinge and a grid support device 163 to support a filter 165 which may filter the air from the exhaust inlet 151. The grid support device 163 may be held in position by a pivot arm 161 which may be pivotably connected to the front member 101. FIG. 21 additionally illustrates the back member 103 which may include the exhaust inlet 151 which may be connected to the exhaust port of the clothes dryer which may exhaust warm air and particulate from the clothes dryer and input the warm air and particulate into the hollow heat distributing device 100. The airflow 167 from the exhaust inlet 151 will flow through the filter 165 to filter out the particulate and the warm air flow 167 will continue out the first exhaust outlet 113, out the second exhaust outlet 153 or alternatively out both the first exhaust outlet 113 or the second exhaust outlet 153.

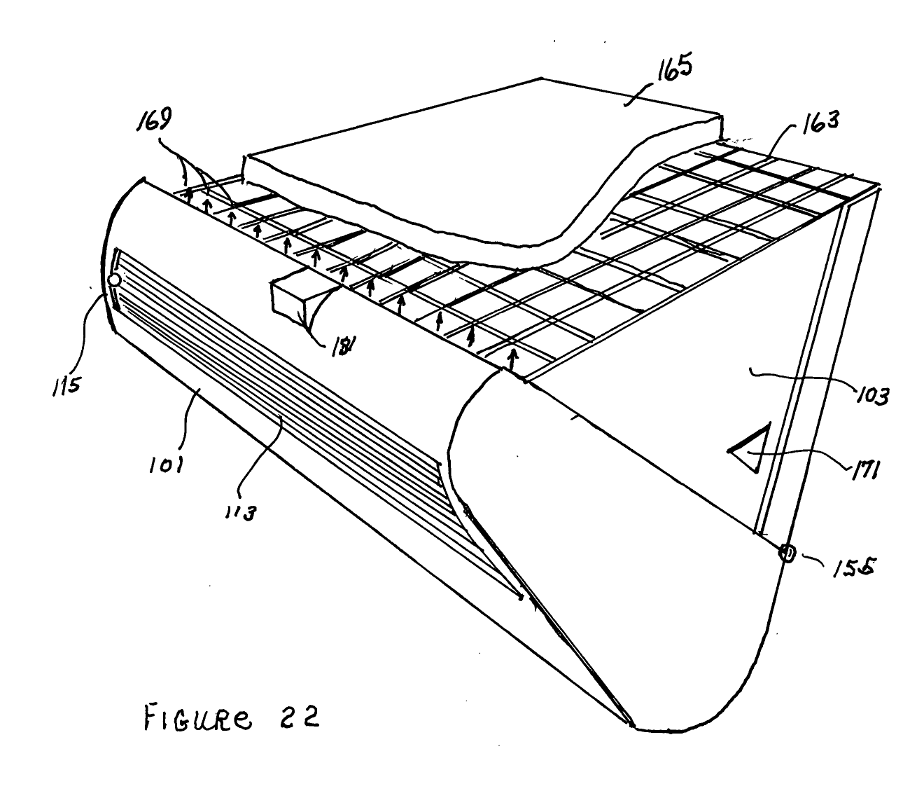

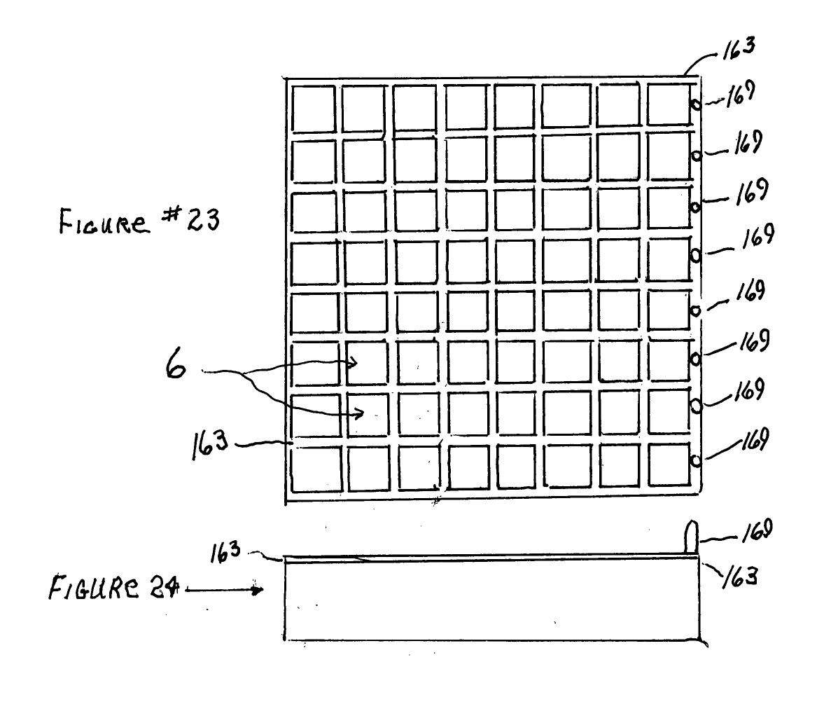

FIG. 22 illustrates the front member 101 in an open position which may include the latch device 131 the first outlet port 113, the front wall 105, the top wall 111 and the side wall 107. FIG. 22 additionally illustrates a grid support device 163 in a open position which may be substantially horizontal in order to allow access to the filter 165 which may be pivotably connected to the top wall 111 for example by a hinge, and a grid support device 163 to support a filter 165 which may filter the air from the exhaust inlet 151. The grid support device 163 may be held in position by a pivot arm 161 which may be pivotably connected to the front member 101. The movement of the pivot arm 161 may be limited by a stop device 171 which may be positioned on the interior surface of the side wall 107. The filter 165 may be conveniently replaced by another filter 165. The grid support device 163 may include an upward extending finger 169 in order to support the filter 165. FIG. 22 additionally illustrates the back member 103 which may include the exhaust inlet 151 which may be connected to the exhaust port of the clothes dryer which may exhaust warm air and particulate from the clothes dryer and input the warm air and particulate into the hollow heat distributing device 100.

FIG. 23 illustrates a top view of the grid support device 163 and illustrates the upward extending finger 169.

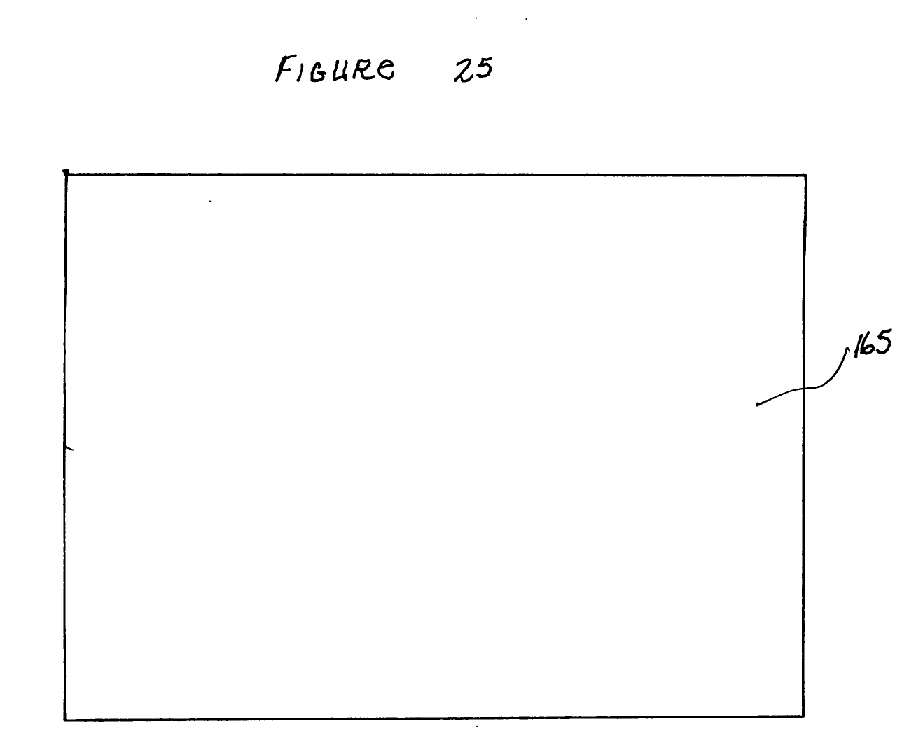

FIG. 24 illustrates a side view of the grid support device 163 and illustrates the upward extending finger 169.

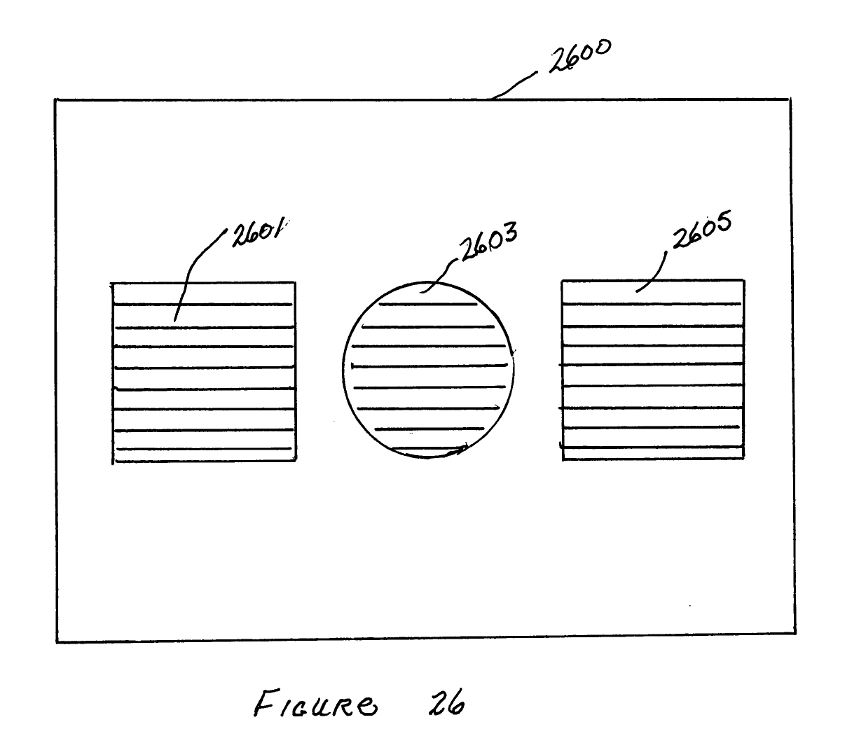

FIG. 25 illustrates a top view of the filter 165 which may be replaceable.

FIG. 26 illustrates a front view of another hollow heat distributing device 2603 which may include a center exhaust outlet port 2603 which may be circular or oval, a pair of opposing rectangular exhaust outlet port 2601, 2605.

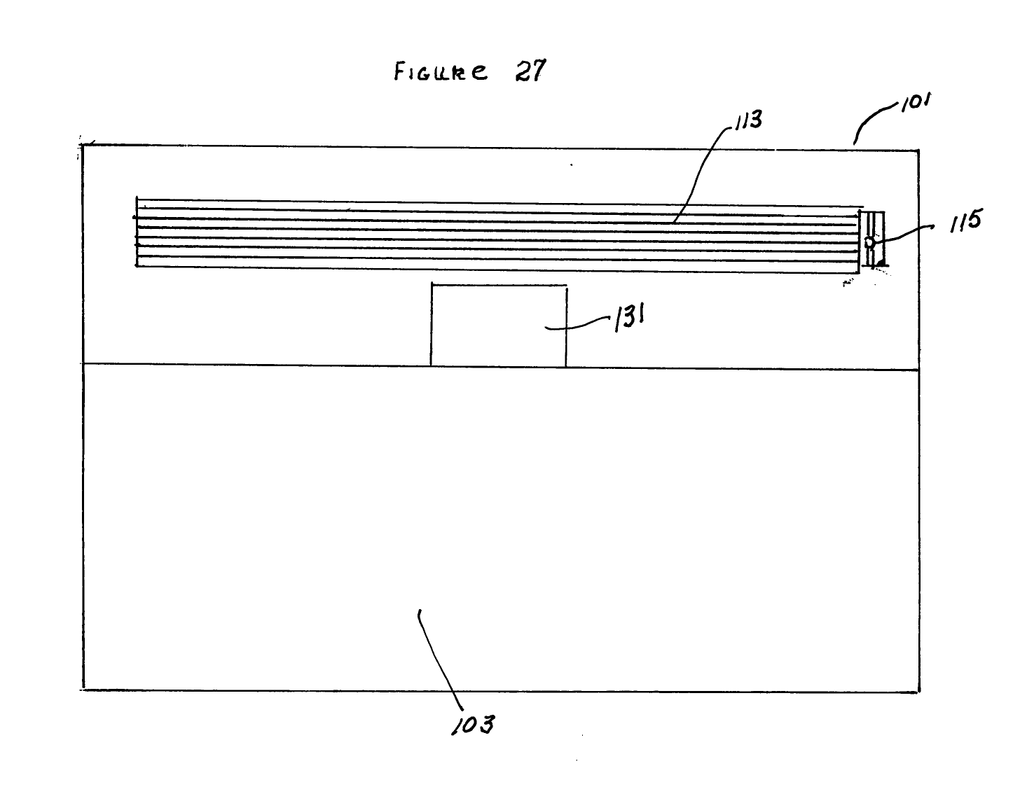

FIG. 27 illustrates a front view of the hollow heat distributing device 100 which may include a front section 1001 which may include first outlet port 113 and the control arm 115. The latch device 131 may be positioned below the first outlet port 113.

FIG. 28 illustrates an interior view of the hollow heat distributing device from a first side and stop device 171;

FIG. 29 illustrates an interior view of the hollow heating distributing device from a second side and stop device 171.

The rectangular housing may be attached to a wall surface, or set on a shelf, table, or other such surfaces. It may also be placed on a floor.

The rectangular housing may be made of a durable acrylic material, or other similar plastic materials, so as to be cost effective in manufacture, durable and light in weight.

The rectangular housing may be attached to a clothes drying machine by means of a readily available flexible hose assembly such as is used to connect the outlet of a clothes drying machine to the outside of a building.

The rectangular housing may hold a flexible filter element that captures dust and lint that is expelled from the clothes drying machine.

The flexible filter element may be disposable and easy to install and replace as necessary.

The outlet openings of the rectangular housing may be used to direct the filtered, warm moist air to either the interior or exterior of a building.

1) A clothes dryer lint filter mechanism for filtering the clothes dryer exhaust air and for directing the heat and humidity inherent in the clothes dryer exhaust air either into the interior of a building or the exterior of a building, the clothes dryer lint filter mechanism, comprising:
a back member;
a front member being pivotally connected to the back member;
an inlet port to be connected to the clothes dryer;
wherein the front member includes a first outlet port;
wherein the back member includes a second outlet port; and
wherein the first outlet port and the second outlet port are selectively controllable.

2) A clothes dryer lint filter mechanism for filtering the clothes dryer exhaust air and for directing the heat and humidity inherent in the clothes dryer exhaust air either into the interior of a building or the exterior of a building, the clothes dryer lint filter mechanism as in claim 1, wherein the first outlet port and the second outlet port are selectively controlled by a control arm.

3) A clothes dryer lint filter mechanism for filtering the clothes dryer exhaust air and for directing the heat and humidity inherent in the clothes dryer exhaust air either into the interior of a building or the exterior of a building, the clothes dryer lint filter mechanism as in claim 1, wherein the housing device includes a filter which is pivotally connected to the front member.

4) A clothes dryer lint filter mechanism for filtering the clothes dryer exhaust air and for directing the heat and humidity inherent in the clothes dryer exhaust air either into the interior of a building or the exterior of a building, the clothes dryer lint filter mechanism as in claim 3, wherein the filter pivots to a substantially horizontal position when the front member is in a open position.

5) A clothes dryer lint filter mechanism for filtering the clothes dryer exhaust air and for directing the heat and humidity inherent in the clothes dryer exhaust air either into the interior of a building or the exterior of a building, the clothes dryer lint filter mechanism as in claim 3, wherein the filter pivots to a position between the input port and the first outlet port and the second outlet port when the front member is in a closed position.

6) A clothes dryer lint filter mechanism for filtering the clothes dryer exhaust air and for directing the heat and humidity inherent in the clothes dryer exhaust air either into the interior of a building or the exterior of a building, the clothes dryer lint filter mechanism as in claim 1, wherein the first outlet port exhausts to the interior.

7) A clothes dryer lint filter mechanism for filtering the clothes dryer exhaust air and for directing the heat and humidity inherent in the clothes dryer exhaust air either into the interior of a building or the exterior of a building, the clothes dryer lint filter mechanism as in claim 1, wherein the second outlet port exhausts to the exterior.

8) A clothes dryer lint filter mechanism for filtering the clothes dryer exhaust air and for directing the heat and humidity inherent in the clothes dryer exhaust air either into the interior of a building or the exterior of a building, the clothes dryer lint filter mechanism as in claim 1, wherein the filter is mounted on a grid support device.

9) A clothes dryer lint filter mechanism for filtering the clothes dryer exhaust air and for directing the heat and humidity inherent in the clothes dryer exhaust air either into the interior of a building or the exterior of a building, the clothes dryer lint filter mechanism as in claim 8, wherein the grid support device includes an upward extending finger to restrain the filter.
